(19) United States
(12) Patent Application Publication
(10) Pub. No.: US 2008/0151723 A1
(43) Pub. Date: Jun. 26, 2008

(54) Apparatus and Method for Reading and/or Writing Information and Method for Controlling a Stepping Motor

(75) Inventor: Cees Hezemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,825

(22) PCT Filed: Jan. 25, 2006
(86) PCT No.: PCT/IB2006/050273

§ 371 Date: Jul. 26, 2007

(30) Foreign Application Priority Data
Jan. 31, 2005 (EP) 05100613.8

(51) Int. Cl. G11B 7/00

(52) U.S. Cl. 369/53.37

(57) ABSTRACT

Disclosed is an apparatus for reading and/or writing information from/to an information carrier (1), comprising a motor (2) for rotating the information carrier (1); pick-up unit (3) for directing a radiation beam (8) on the information carrier (1 ); traverse means having a permanent magnet stepping motor (6) for moving said pick-up unit from one read/write position on the information carrier to another read/write position; stepping motor driving means (7) for supplying said stepping motor with driving currents for coils in the stepping motor which generate magnetic fields, wherein the stepping motor driving means (7) has an open loop driving mode at which the read/write positions correspond to rest positions of the stepping motor (6) at which the magnetic fields generated by at least two coils (23, 34) in the stepping motor counteract each other. The inventor has surprisingly observed that the positioning accuracy at rest positions at which the magnetic fields generated by at least two coils counteract each other, is higher than at rest positions where these magnetic fields do not counteract each other. An explanation for this behavior is as follows. A permanent magnet stepping motor has, as the name implies, a permanent magnet rotor. The coils in the permanent magnet stepper motor generate an magnetic field when a current is applied to them. The coils are winded around iron core(s) which improve the magnetic field(s). The iron in the magnetic magnetic system of a permanent magnet stepper motor as used in optical drives is on the edge of saturation when no magnetic field is generated by the coils. The extra magnetic field generated by the current through the coils will modulate this saturation more when the magnetic fields are in the same direction, and less when the magnetic field counteract each other. If the iron is more saturated, the position accuracy will diminish. Therefore, at rest positions where the magnetic fields counteract each other, the saturation will be less and the position accuracy will be better.

The invention relates to an apparatus for reading and/or writing information from/to an information carrier, comprising
a motor for rotating the information carrier;
pick-up unit for directing a radiation beam on the information carrier;
traverse means having a permanent magnet stepping motor for moving said pick-up unit from one read/write position on the information carrier to another read/write position;
stepping motor driving means for supplying said stepping motor with driving currents for coils in the stepping motor which generate magnetic fields.

The invention further relates to a method for controlling a permanent magnet stepping motor, comprising the step of generating magnetic fields by feeding currents to coils in the stepping motor, wherein the magnetic field cause a rotor of the stepping motor to rotate from one rest position to another.

The invention also relates to a method for reading and/or writing information from/to an information carrier, comprising the steps of:
rotating the information carrier;
directing a radiation beam, generated by a pick-up unit, on the information carrier;
moving said pick-up unit from one read/write position to another read/write position, wherein the pick-up unit is moved via a permanent magnet stepping motor;

supplying said stepping motor with driving currents for coils in the stepping motor which generate magnetic fields.

An apparatus for reading and/or writing information from/to an information carrier that uses a stepping motor as a traverse motor for feeding the pick-up unit is already commercialized. CD, DVD and Blu-Ray disc drives are examples of such apparatuses. Recently optical disc drives have been introduced on the market which create a label on an optical disc by utilizing a laser beam output from a pick-up unit of the optical disc drive.

Herein the visible light characteristic of a radiation sensitive layer on the optical disc is changed. When writing information on the information carrier (optical disc) the radiation beam is radially positioned on a track of the information carrier via a servo system. The servo system controls the position of the radiation beam by positioning the pick-unit in radial direction and by positioning an objective lens on the pick-up unit relative to the pick-up unit.

When writing a label to the optical disc, the optical disc is set on a turntable of an optical disk unit while the label surface of the optical disk is directed towards an optical pick-up unit. The optical disc and the pick-up unit are moved mutually to cover a label area along the plane of the optical disc. In synchronism with the relative movement, the power of a laser beam output from the optical pick-up unit is modulated in accordance with image data, such as characters or graphic images to be printed. As a result of the radiation sensitive layer being exposed to the laser beam, a visible-light reflectivity of the radiation sensitive layer is changed, thereby forming an image corresponding to the image data on the label surface.

The patent application US 2001/0017824 describes a method for controlling a stepping motor. A stepping motor is described having two coils and a rotor having some pairs of N ans S magnetic poles. The number of magnetic pole pairs differ among types of stepping motors. The rotor begins rotating when a current flowing through a first coil and a current flowing through a second coil are changed. The rotor stops when the balance between the magnetic force generated from those coils and the frictional load of rotation is stabilized. This is called rest position. In US 2001/0017824 the following rest positions are subsequently stepped through:
position A wherein the current through the first coil is positive and the current through the second coil is negative;
position B wherein the current through the first coil is positive and the current through the second coil is zero;
position C wherein the current through the first coil is positive and the current through the second coil is positive;
position D wherein the current through the first coil is zero and the current through the second coil is positive;
position E wherein the current through the first coil is negative and the current through the second coil is positive;
position F wherein the current through the first coil is negative and the current through the second coil is zero;
position G wherein the current through the first coil is negative and the current through the second coil is negative;
position H wherein the current through the first coil is zero and the current through the second coil is negative;

In label writing applications, such as LightScribe, the positioning of the pick-up unit is performed in open loop. This means that the radial error of the label writing light spot is the sum of the error of the position of the pick-up unit and of the relative error between the objective lens and the pick-up unit. The label writing applications currently use a track spacing of approximately 10 to 25 μm. The positioning error of the label writing light spot must therefore be smaller than approximately 10 μm. This means that in such label writing applications the demand of positioning accuracy of the pick-up unit and therefore the stepper motor has become more severe.

Therefore, it is a first object of the invention to provide an apparatus and method which is able to position the pick-up unit more accurate.

It is a second object of the invention to provide a method for controlling a stepper motor which is able to control the stepper motor more accurate.

According to a first aspect of the invention the first object is achieved with an apparatus as defined in the opening paragraph in which the stepping motor driving means has an open loop driving mode at which the read/write positions correspond to rest positions of the stepping motor at which the magnetic fields generated by at least two coils in the stepping motor counteract each other.

According to a second aspect of the invention the first object is achieved with a method as defined in the opening paragraph which method further comprises an open loop driving step wherein the read/write positions correspond to rest positions of the stepping motor at which the magnetic fields generated by at least two coils in the stepping motor counteract each other.

According to a third aspect of the invention the second object is achieved with a method of controlling a stepper motor as defined in the opening paragraph wherein the rest positions are positions at which the magnetic fields generated by at least two coils counteract each other.

The inventor has surprisingly observed that the positioning accuracy at rest positions at which the magnetic fields generated by at least two coils counteract each other, is higher than at rest positions where these magnetic fields do not counteract each other. An explanation for this behavior is as follows.

A permanent magnet stepping motor has, as the name implies, a permanent magnet rotor. The rotor has n poles, n/2 south and n/2 north poles arranged around its circumference. n is an integer, and can be for instance 4, 6, 8 or 10, etc. The angle which the rotor rotates per step depends on the number of poles and the number of coils. The coils in the permanent magnet stepper motor generate an magnetic field when a current is applied to them. The coils are winded around iron core(s) which improve the magnetic field(s). The iron in the magnetic system of a permanent magnet stepper motor as used in optical drives is on the edge of saturation when no magnetic field is generated by the coils. The extra magnetic field generated by the current through the coils will modulate this saturation more when the magnetic fields are in the same direction, and less when the magnetic field counteract each other. If the iron is more saturated, the position accuracy will diminish. Therefore, at rest positions where the magnetic fields counteract each other, the saturation will be less and the position accuracy will be better.

In a further embodiment of the apparatus according to the invention, the apparatus further comprises label writing means for writing a label to the information carrier by directing the radiation beam to a radiation sensitive layer on the information carrier and wherein the open loop driving mode is used for moving the pick-up means when writing the label. The invention is particularly advantageous for label writing applications because in these applications there is no feedback as to what the radial position of the current label writing position is. Because the stepping motor is controlled in a more accurate way, the quality of a label which is written in an open loop control is improved.

In US 2001/0017824 there are two positions at which the magnetic fields counteract each other. In the method and apparatus according to the current invention in all the rest positions the magnetic fields counteract each other. Consequently, all rest positions have a higher positions accuracy.

These and other aspects of the invention will be apparent from and elucidated further with reference to the embodiments described by way of example in the following description and with reference to the accompanying drawings, in which

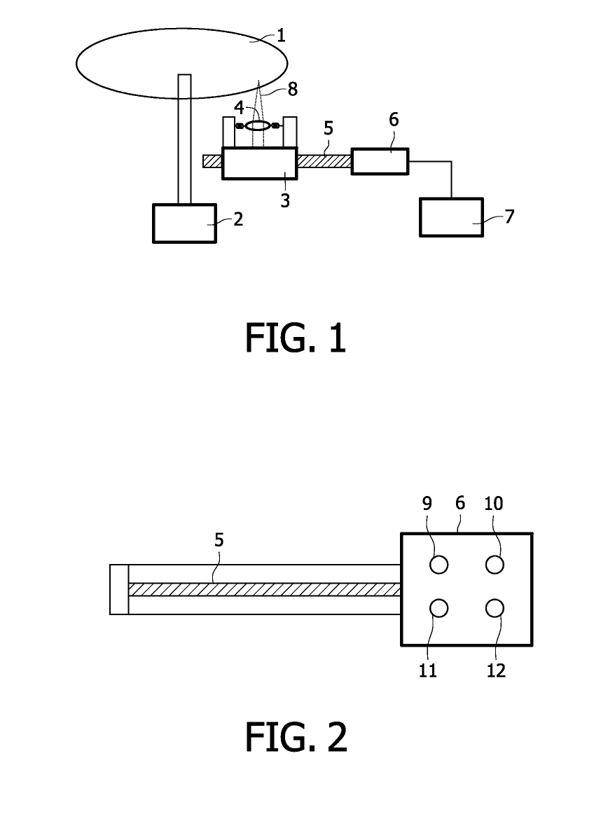

FIG. 1 shows an apparatus for reading and/or writing information from/to an information carrier according to the invention,

FIG. 2 shows traverse means with a permanent magnet stepping motor,

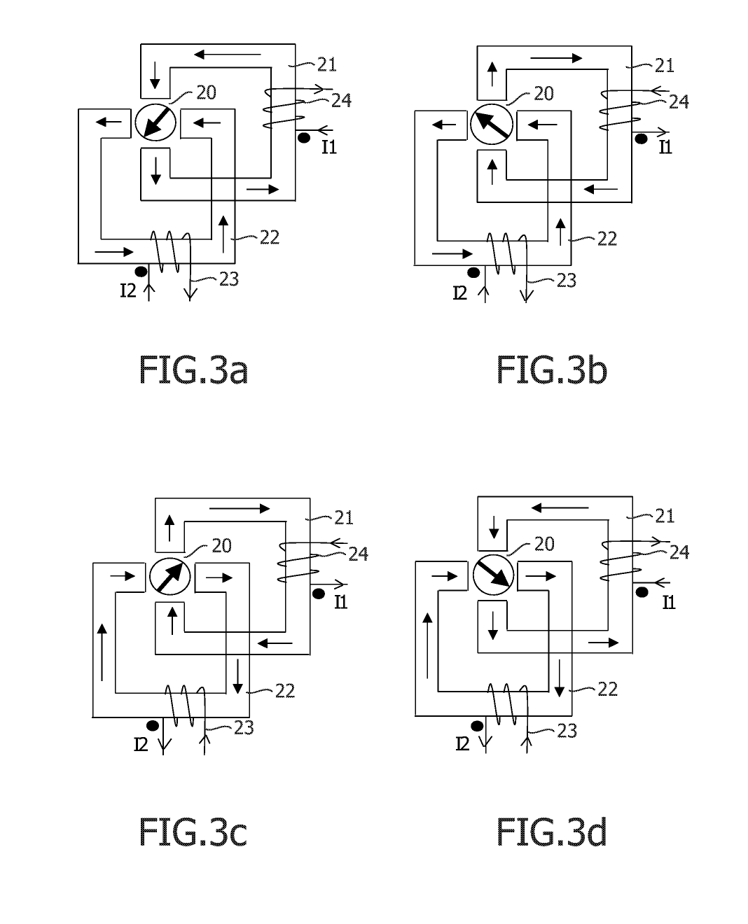

FIG. 3a shows a schematic diagram of a permanent magnet stepping motor wherein the magnetic fields strengthen each other,

FIG. 3b shows a schematic diagram of a permanent magnet stepping motor wherein the magnetic fields counteract each other,

FIG. 3c shows a schematic diagram of a permanent magnet stepping motor wherein the magnetic fields strengthen each other,

FIG. 3d shows a schematic diagram of a permanent magnet stepping motor wherein the magnetic fields counteract each other,

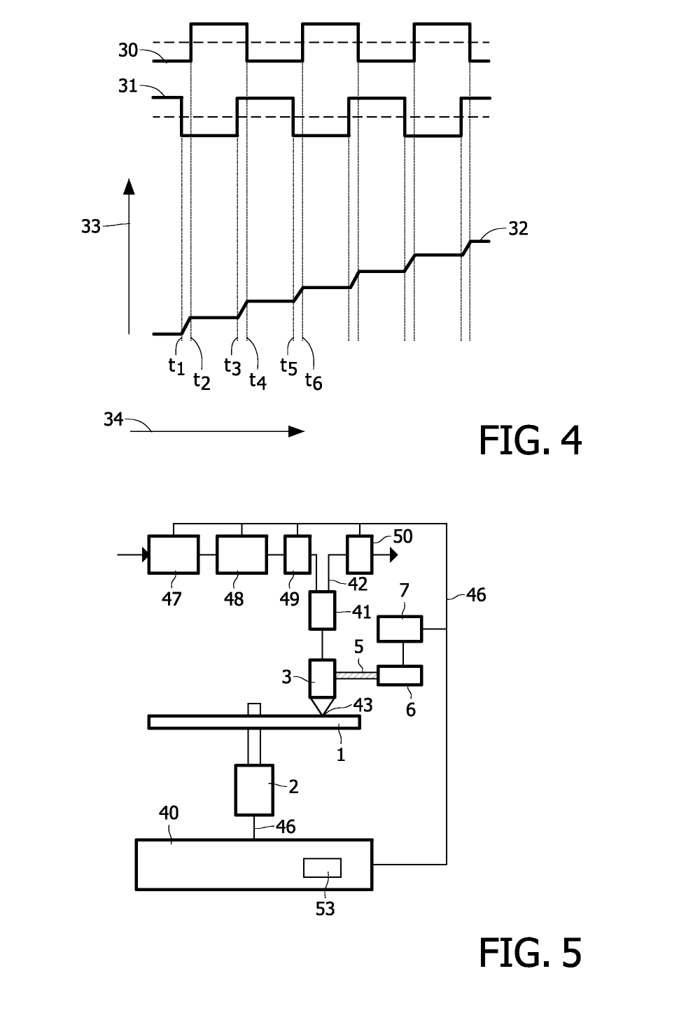

FIG. 4 shows a timing diagram of the currents through the coils of the stepping motor and the position of the pick-up unit, and

FIG. 5 shows an apparatus for writing information to an information carrier according to the invention comprising label writing means.

In FIG. 1 an information carrier 1 is rotated by a spindle motor 2. An optical pick-up unit 3 has radiation means, i.e. a laser unit, which generates a radiation beam 8. The radiation beam 8 is focussed on the information carrier 1 with an objective lens 4. When reading information from the information carrier 1 the radiation beam is reflected by the information carrier 1 and transformed into an electronic signal by a detector. The electronic signal is further processed to recreate the data on the information carrier 1. When writing information to the information carrier 1 the radiation beam 8 has a higher power and creates marks on the information carrier 1. The marks correspond to the data to be written on the information carrier 1. The radiation beam 8 can be positioned radially by moving the objective lens 4 relative to the pick-up unit 3. This is a fine positioning. In order to be able to cover whole the surface of the information carrier 1, the pick-up unit 3 can be positioned by the traverse means. The traverse means comprises a spindle 5 and a stepping motor 6. The stepping motor 6 in this case is a permanent magnet stepping motor. The stepping motor 6 is rotated stepwise. The stepping motor 6 drives the spindle 5 which in its turn moves the pick-up unit 3. The stepping motor 6 is controlled by stepping motor driving means 7 which supplies driving currents to the coils in the stepping motor 6. The apparatus has two modes of operation, a recording mode, and a label mode. In the label mode the information carrier is to be entered in the apparatus with its label side towards the pick-up unit to allow the beam of radiation to be focussed to a spot on the radiation sensitive layer of the label side. When an information carrier is entered, the user may give a command to engage the label mode. In practice the idea in label mode is to print labels at the non-data side of a CD or DVD disc. In both cases a CD laser in the pick-up unit may be used to write the label. The positioning of the pick-up unit in radial direction is performed by an open loop control, because no tracks or position information such as addresses are available. Because of the lack of feedback of the position, it is important to position the pick-up unit as accurate as possible in open loop mode. The invention deals with this problem.

In FIG. 2 the traverse means are depicted in more detail. The stepper motor 6 drives a spindle 5. There are four contacts 9, 10, 11 and 12, for the coils in the stepper motor. Depending on the drive current fed to these contacts, the stepper motor 6 can be controlled to make steps of a certain angle.

In FIGS. 3a to 3d schematic diagrams show the inside of the stepper motor 6. In this stepper motor 6 there are two coils present, coil 23 and coil 24. Through the coil 24 a driving current I1 is fed and through the coil 23 a driving current I2 is fed. The arrow in the rotor 20 depicts the angle position of the rotor 20. The direction of the currents I1 and I2 as shown in FIG. 3a are defined as positive. The magnetic fields generated by the coils 23 and 24 in FIG. 3a run through the iron cores 21 and 22. The magnetic fields in FIG. 3a strengthen each other. As a consequence the iron cores 21 and 22 become more saturated.

In FIG. 3b the driving current I2 through coil 23 is positive and the driving current I1 through coil 24 is negative. The magnetic fields generated by the coils 23 and 24 now counteract each other. The rotor 20 is consequently rotated 90 degrees. In FIG. 3c both driving currents I1 and I2 are both negative and the magnetic fields strengthen each other. Again the rotor 20 has made a step of 90 degrees. In FIG. 3d the driving current I1 is positive and the driving current I2 is negative. The magnetic fields consequently counteract each other. Again the rotor 20 has made a step of 90 degrees.

In FIG. 4 the wave form 30 indicates the driving current I1 through coil 24 and the waveform 31 indicates the driving current I2. The dashed lines slicing through these waveforms indicate the zero level of the driving currents. Arrow 34 indicates the direction of time. Waveform 32 indicates the position of the pick-up unit as a result from the driving currents fed to the stepping motor 6. Arrow 33 indicates the radial position of the pick-up unit 3. Before time instant t1 the driving current I1 is negative and the driving current I2 is positive. This corresponds with the situation depicted in FIG. 3b. Between time instants t1 and t2 the driving currents I1 and I2 are both negative. This corresponds to the situation depicted in FIG. 3c. This position is not a rest position of the stepper motor according to the invention, but only a transitional position to arrive to the rest position of FIG. 3d. Between time instants t2 and t3 the driving current I1 is positive and the driving current I2 is negative. This corresponds to the situation depicted in FIG. 3d. Between time instants t3 and t4 both driving currents I1 and I2 are positive. This corresponds with the situation depicted in FIG. 3a. Again this is not a rest position of the stepper motor according to the invention, but only a transitional position to arrive to the rest position of FIG. 3b. Between time instants t4 and t5 the driving current I1 is negative and the driving current I2 is positive. This corresponds to the situation depicted in FIG. 3b. Consequently, the rest position which are used for reading and/or writing are either the position indicated in FIG. 3b or FIG. 3d. In these positions the magnetic fields generated by the coils 23 and 24 counteract each other and the iron cores 21 and 22 become less saturated.

The inventor has tested two types of permanent magnet stepper motors 6 in which test he controlled the stepper motor 6 corresponding to FIG. 3a, 3b, 3c and 3d. In the test environment the one complete rotation of the rotor 20 of the stepper motor 6 corresponded to 600 μm. The individual steps of 90 degrees thus corresponds to steps of 150 μm. The test results for two different types of permanent stepper motors 6 are shown in table 1.

TABLE 1

| | maximum position error of | maximum position error of |
|---|---|---|
| Stepper | pick-up unit in situations of | pick-up unit in situations of |
| motor type | FIG. 3b and 3d [μm] | FIG. 3a and 3c [μm] |
| MOA 075k | 2 | 4 |
| SaSe V04 | 4 | 10 |

In the first column of table 1 the motor type is indicated. The second column contains the maximum position error of the expected position and the measured position of the pick-up unit 3 when the stepper motor 6 is in situations of FIG. 3b or 3d. The pick-up unit position is measured with a microscope. The third column gives the maximum position error of the pick-up unit when the stepper motor 6 is in situations of FIG. 3a or 3c. It is clear from table 1 that the position error of the pick-up unit 3 is approximately 2 times better when the magnetic fields of the coils 23 and 24 counteract each other as compared to the situation where the magnetic field strengthen each other.

It is observed that once the rotor 20 is at its rest position as depicted in FIG. 3b or FIG. 3d the driving currents I1 and I2 do not necessary need to be maintained. After the rotor 20 is at its rest position, the driving currents I1 and I2 can be brought back to zero until the stepper motor 6 needs to make a step again.

FIG. 5 shows an apparatus having label writing capability. The device is provided with means for scanning a track on the information carrier 1, which means include a spindle motor 2 for rotating the information carrier 1, a pick-up unit 3, traverse means comprising a stepper motor 6 and a spindle 5 for positioning the pick-up unit 3 on the track and a control unit 40. The stepper motor 6 is controlled by the stepper motor driving means 7. The pick-up unit 3, also called OPU (Optical Pickup Unit), comprises an optical system of a known type for generating a radiation beam 8 guided through optical elements focused to a radiation spot 43 on a track of the information layer of the information carrier 1. The radiation beam 8 is generated by a radiation source, e.g. a laser diode. The pick-up unit 3 further comprises (not shown) a focusing actuator for focusing the beam to the radiation spot 43 on the track by moving the focus of the radiation beam 8 along the optical axis of said beam, and a tracking actuator for fine positioning of the spot 43 in a radial direction on the center of the track. The tracking actuator may comprise coils for radially moving an optical element for following the track. The radiation reflected by the information layer is detected by a detector of a usual type in the pick-up unit 3.

A front-end unit 41 is coupled to the detector in the pick-up unit 3 for providing detector signals based on radiation reflected from the track. The detector signals may include a main scanning signal 42 for reading the marks and sub-detector signals, for example a push-pull sub-detector signal based on the radiation as reflected from a left and right side of the track respectively and/or a satellite sub-detector signal based on the radiation as reflected from separate satellite spots positioned to the left and right side of the center of the track. The main scanning signal 42 is processed by read processing unit 50 of a usual type including a demodulator, deformatter and output unit to retrieve the information.

The control unit 40 controls the recording and retrieving of information and may be arranged for receiving commands from a user or from a host computer. The control unit 40 is connected via control lines 46, e.g. a system bus, to the other units in the device. The control unit 40 comprises control circuitry, for example a microprocessor, a program memory and interfaces for performing the procedures and functions as described below. The control unit 40 may also be implemented as a state machine in logic circuits.

The device is provided with recording means for recording information on record carriers of a writeable or re-writeable type. The recording means cooperate with the pick-up unit 3 and front-end unit 41 for generating a write beam of radiation, and comprise write processing means for processing the input information to generate a write signal to drive the pick-up unit 3, which write processing means comprise an input unit 47, a formatter 48 and a modulator 49. For writing information the power of the beam of radiation is controlled by modulator 49 to create the optically detectable marks in the recording layer.

In an embodiment the input unit 47 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

The device has two modes of operation, a recording mode for conventionally recording optical discs as described above, and a label mode. The control unit 40 is for controlling the recording in the recording mode. The control unit comprises a label writing means 53 for controlling the scribing in the label mode.

In the label mode the record carrier is to be entered in the device with its label side towards the optical head to allow the beam of radiation to be focused to a scribing spot on the radiation sensitive layer of the label side. When an information carrier 1 is entered, the user may give a command to engage the label mode. Alternatively the device may automatically detect if a suitable record carrier for label write has been entered, for example by detecting prescribed marks on a predefined location on the information carrier 1.

Although the invention has been mainly explained by embodiments using optical discs having a label layer, the invention is also suitable for other record carriers such as rectangular optical cards, magneto-optical discs or any other type of information storage system that applies record carriers scanned via a beam of radiation. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. An apparatus for reading and/or writing information from/to an information carrier (1), comprising
a motor (2) for rotating the information carrier (1);
pick-up unit (3) for directing a radiation beam (8) on the information carrier (1);
traverse means (5, 6) having a permanent magnet stepping motor (6) for moving said pick-up unit (3) from one read/write position on the information carrier (1) to another read/write position;
stepping motor driving means (7) for supplying said stepping motor (6) with driving currents for coils (23, 24) in the stepping motor (6) which generate magnetic fields,
characterized in that the stepping motor driving means (7) has an open loop driving mode at which the read/write positions correspond to rest positions of the stepping motor (6) at which the magnetic fields generated by at least two coils (23, 34) in the stepping motor counteract each other.

2. An apparatus as claimed in claim 1, wherein the apparatus further comprises label writing means (53) for writing a label to the information carrier (1) by directing the radiation beam (8) to a radiation sensitive layer on the information carrier (1) and wherein the open loop driving mode is used for moving the pick-up unit (3) when writing the label.

3. Method for controlling a permanent magnet stepping motor (6), comprising the step of generating magnetic fields by feeding currents to coils (23, 24) in the stepping motor, wherein the magnetic field cause a rotor (20) of the stepping motor (6) to rotate from one rest position to another,
characterized in that the rest positions are positions at which the magnetic fields generated by at least two coils (23,24) counteract each other.

4. Method for reading and/or writing information from/to an information carrier (1), comprising the steps of:
rotating the information carrier (1);
directing a radiation beam (8), generated by a pick-up unit (3), on the information carrier (1);
moving said pick-up unit (3) from one read/write position to another read/write position, wherein the pick-up unit (3) is moved via a permanent magnet stepping motor (6);
supplying said stepping motor (6) with driving currents for coils in the stepping motor (6) which generate magnetic fields,
characterized in that the method further comprises an open loop driving step wherein the read/write positions correspond to rest positions of the stepping motor (6) at which the magnetic fields generated by at least two coils (23, 24) in the stepping motor (6) counteract each other.

5. Method as claimed in claim 4, further comprising a label writing step wherein a label is written to the information carrier (1) by directing the radiation beam (8) to a radiation sensitive layer on the information carrier (1) and wherein the open loop driving step is used to move the pickup unit (3) when writing the label.
